(19) United States
(12) Patent Application Publication
(10) Pub. No.: US 2014/0291257 A1
(43) Pub. Date: Oct. 2, 2014

(54) LIQUID TREATMENT REFINING AND RECYCLING

(71) Applicant: HOWARD SCHACHTER, RIVERSIDE, RI (US)

(72) Inventor: HOWARD SCHACHTER, RIVERSIDE, RI (US)

(21) Appl. No.: 14/038,130

(22) Filed: Sep. 26, 2013

Related U.S. Application Data
(60) Provisional application No. 61/720,162, filed on Oct. 30, 2012.

(51) Int. Cl. C02F 1/46; C02F 1/463; C02F 1/78

(52) U.S. Cl. CPC C02F 1/4608; C02F 1/78; C02F 1/463
USPC 210/748.16; 210/200; 210/138; 204/666; 204/663

(57) ABSTRACT

A water treatment device and related method of operation may include receiving used, dirty and/or waste water from a well or other source of water. The water may then be prepared for a voltage treatment by injecting a gas into the water, treating the water with pH adjustments and then applying a voltage to the water in order to remove the sediment from the water to provide a recycled water for continued use.

### CROSS-REFERENCE TO RELATED APPLICATIONS

This application claims priority to earlier filed provisional application No. 61/720,162 filed on Oct. 30, 2012 and entitled “METHOD AND APPARATUS FOR RECYCLING WATER USED WITH HEAVY INDUSTRIAL PURPOSES”, the entire contents of which are hereby incorporated by reference.

### TECHNICAL FIELD OF THE APPLICATION

This application relates to a method and device used for recycling, filtering and/or removing minerals and other sediment from water that has been exposed to an industrial work cycle.

### BACKGROUND OF THE INVENTION

Conventionally, water or similar liquid compositions may be used to perform drilling and may also be used for other industrial purposes. The amount of water available for use may be inversely proportional to the remoteness of the site where the drilling occurs. Also, clean or sediment free water being brought to remote locations is a large expense which results in losses in profits or other degradations in the mining process.

In one conventional example, water must be brought to a drill site and added to the drilling spot to cool and soften the earth in the case of mining oil or other deep ground resources. Once the water has been exposed to the earth, dirt and sediment of the mining drill bit or other machinery, the water becomes murky, dark and saturated with minerals and other sediments which must be removed before the water can be used again.

In another example, water may be used for hydraulic fracturing, which is the propagation of fractures in a rock layer, as a result of the action of a pressurized fluid. Some hydraulic fractures form veins or dikes, and can create conduits along which gas and petroleum from source rocks may migrate to reservoir rocks. Induced hydraulic fracturing or ‘hydrofracking’, commonly known as ‘fraccing’ or ‘fracking’, is a technique used to release petroleum, natural gas (including shale gas, tight gas and coal seam gas), or other substances for extraction. This type of fracturing creates fractures from a wellbore drilled into reservoir rock formations.

Regardless of the water use purpose, the water on-site would ideally be re-used again, and again, without any delay so the mining and drilling can be performed continuously. Unfortunately, the water is often saturated with sediment and mineral deposits rather quickly and must be pumped out of the mining channel so new fresh water can be added for continuous mining operations.

### SUMMARY OF THE INVENTION

One example embodiment may provide an apparatus that includes a liquid input source that provides a predetermined number of liquid gallons, and a gas input source that provides a gas injection to the liquid. The apparatus may also include an electrode array that includes a plurality of electrodes configured to receive the liquid and apply a direct current voltage to the liquid.

Another example embodiment may provide a method that includes receiving a flow of liquid via a forced liquid input interface, receiving a gas injection via a gas input interface and mixing the gas with the liquid, applying a voltage to the liquid for a predetermined amount of time, and reversing the polarity of the voltage and applying the reversed polarity voltage to the liquid.

Another example embodiment may include an apparatus that provides an array of electrode cells configured to store a liquid, a liquid interface source that provides a flow of liquid into the array of electrode cells, the liquid comprising a plurality of sediment materials, a power supply interface in contact with the liquid and configured to receive a voltage source, and a chemical interface configured to receive a polymer that mixes with the liquid in the electrode cells during application of the voltage source.

### BRIEF DESCRIPTION OF THE DRAWINGS

FIG. 1 illustrates an example of a water treatment device according to example embodiments.

FIG. 2 illustrates an example of the electrode and voltage application portion of the water treatment device according to example embodiments.

FIG. 3 illustrates an example of the water flow and storage tank device used with the water treatment device according to example embodiments.

FIG. 4 illustrates a flow diagram of an example method of operation.

FIG. 5 illustrates a flow diagram of another example method of operation.

### DETAILED DESCRIPTION OF THE INVENTION

It will be readily understood that the components of the present invention, as generally described and illustrated in the figures herein, may be arranged and designed in a wide variety of different configurations. Thus, the following detailed description of the embodiments of a method, apparatus, and system, as represented in the attached figures, is not intended to limit the scope of the invention, but is merely representative of selected embodiments of the invention.

The features, structures, or characteristics of the invention described throughout this specification may be combined in any suitable manner in one or more embodiments. For example, the usage of the phrases “example embodiments”, “some embodiments”, or other similar language, throughout this specification refers to the fact that a particular feature, structure, or characteristic described in connection with the embodiment may be included in at least one embodiment of the present invention. Thus, appearances of the phrases “example embodiments”, “in some embodiments”, “in other embodiments”, or other similar language, throughout this specification do not necessarily all refer to the same group of embodiments, and the described features, structures, or characteristics may be combined in any suitable manner in one or more embodiments.

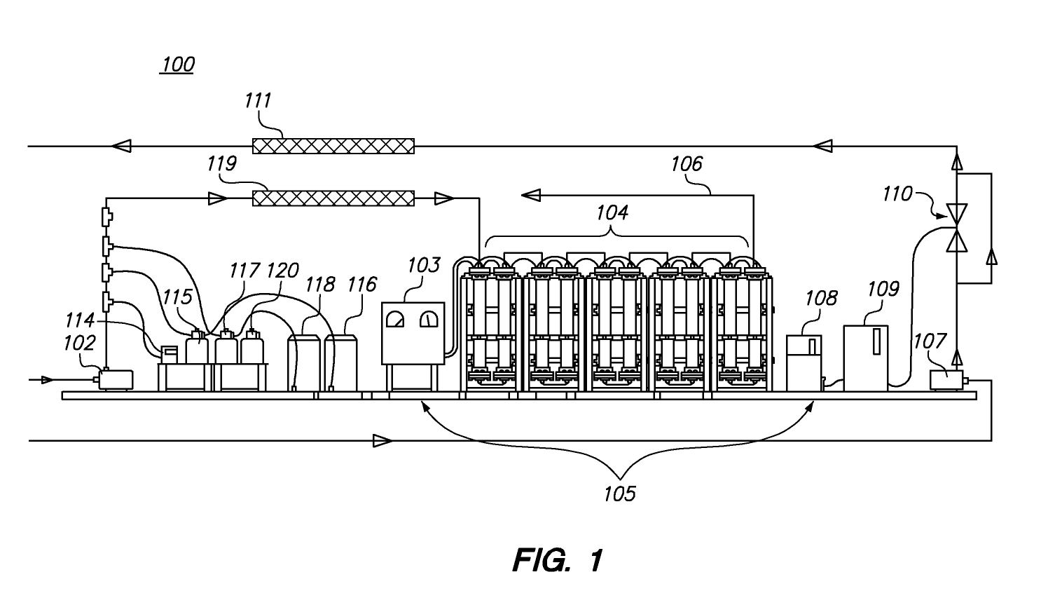

FIG. 1 illustrates an example water treatment and refinement device configuration. Referring to FIG. 1, the various items of the water treatment device 100 are exemplary in nature and may be modified by one skilled in the art to accommodate various design considerations according to the example embodiments.

In one example, piping and valves used for water flow may be schedule-40 PVC grade. Other piping considerations may be copper or other types of plastic. The electric water pump 102 may be a 3.0 HP centrifugal 50 gallons per minute (GPM) grade pump, however, a faster or slower pump may operate as well to pump the “used”, “frac” or “dirty” water into the water treatment device. According to other example embodiments, the pump size may be 10 HP with a flow rate of 125 GPM.

Within the water flow system of pipes moving through the water treatment device, a set of six electrocoagulation chambers or ‘electrodes’ may be part of an electrode array 104 used to treat the water and remove sediment from the used water. The number of electrodes may be greater or fewer depending on the amount of water flow, the degree or amount of sediment included in the water and the level of current and/or voltage provided by each electrode. The power supplied may be from a 200 ampere electrocoagulation DC power supply 103. The electrode array may have 10 electrode chambers according to example embodiments.

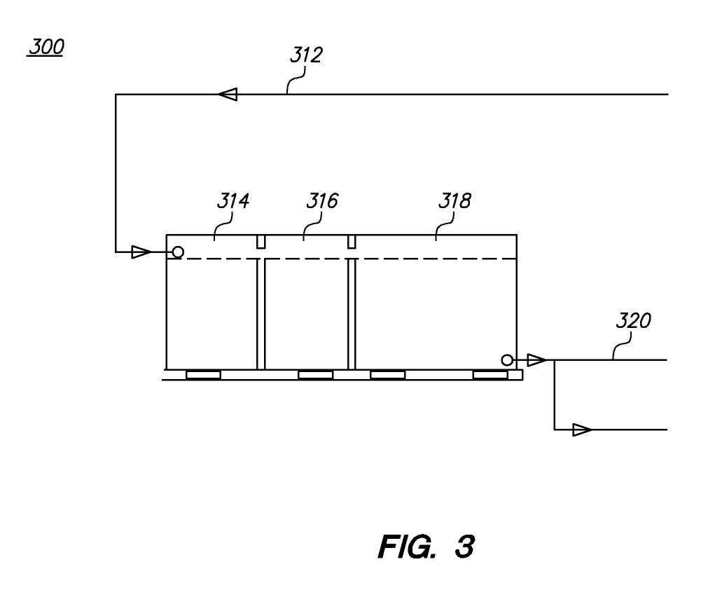

The water treatment system may be fully palletized in a self-contained module 105 for easy forklift compatibility and mobility. The ozone generation of water treatment may also be part of a high efficiency corona discharge type of operation. For example, a recirculation pump 107 may be used to generate a 3.0 horse power (HP) centrifugal pump cycle of 50 GPM of water flow. The pump 107 may also be a 7.5 HP pump at 125 GPM. An oxygen concentrator module 108 may generate the oxygen molecules needed for the ozone injection module 109 to inject the ozone via an ozone injection interface 110. The pump may be used to generate a 16 gallon per-minute flow via an injector module. The ozonated water is then sent through a static mixer 111 for further ozone saturation. The ozonated water is then recirculated back to the main storage tank 300 of FIG. 3. The tanks of FIG. 3 are for example purposes only and are not intended to limit the scope of the water treatment device and/or the methods of water treatment. The tanks or water treatment chambers may be made by any third party manufacturer and are merely auxiliary components of the example embodiments of the present application.

A chemical metering pump 115 may be used to administer a pH adjusting chemical stored in the acid/alkaline tank 116. A polymer feeding pump 117 may be used for adjusting polymer content levels from a polymer stored in polymer tank 118 that is used to bind to the sediment in the water and create a heavy solid that is denser than the water and which falls via gravity to a lower position in the electrode chambers 104 and may be easily removed via a filter or tray removal operation at the bottom of the electrode array. The backup pump 120 may be used in case of a pump failure. The pH monitoring device 114 provides an automatic pH adjustment action to maintain the pH at a particular level by initiating the pH pump to add more acid/alkaline or stop adding pH adjustment chemicals to the water. Also a totalizer or transmitter 106 may be integrated into the flow of water to identify the total volume currently being treated at a particular time interval.

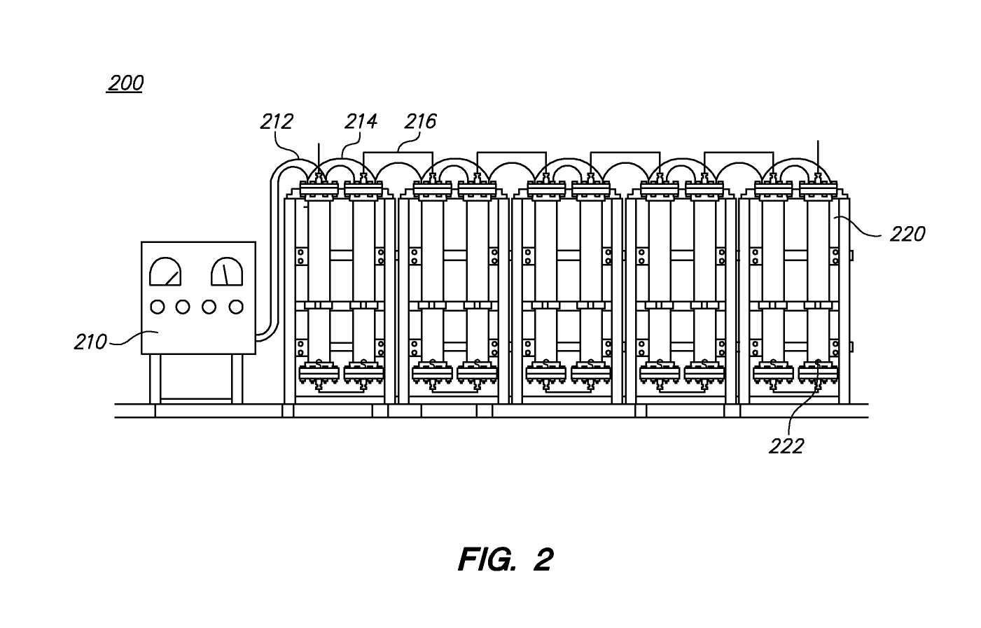

An electro-coalescing scenario may include ozones being injected in the water during primary stages and continuously during the electrode chamber refinement procedure. Once the used, dirty and/or waste water enters the electrode assembly of six electrodes (see 104 of FIG. 1 or 200 of FIG. 2) laid in a series configuration, the electric charge exposed to the water may be conducted during the water flow procedure from electrodes 1-6 or in other examples 1-10. The electrodes provide a DC voltage source that provides a DC current to the water that causes the metals and other minerals to begin binding together into clusters based on a varying DC voltage source coupled to the electrodes.

According to one example embodiment, the DC voltage provided by the voltage source may be provided to each electrode uniformly at a set interval of time (e.g., 15, 30, 45, 60, 75, 90 seconds, etc.). For example, a DC voltage may be applied to the electrodes so one portion of each electrode is generating a current based on first voltage polarity (i.e., positive or negative) from one electrode portion to the other of the two electrode portions (anode and cathode) in each electrode chamber or cell.

The anode in each of the electrochemical cells may be defined as the positive electrode at which electrons leave the cell and oxidation occurs, and the cathode may be the negative portion of the electrode where at which electrons enter the cell and reduction occurs. Each electrode rod in FIG. 1 may become either the anode or the cathode depending on the direction of current through the cell. Each of the three pairs of electrodes includes three anodes and three cathodes. Or, alternatively may include 5 anodes and 5 cathodes in the case of additional electrodes.

Among the different types of electrodes, a primary cell is a special type of electrochemical cell in which the reaction cannot be reversed, and the identities of the anode and cathode are therefore fixed. The anode is always the negative electrode. The cell can be discharged but not recharged. In another type of electrode, a secondary cell (e.g., a rechargeable battery) may be an electrode in which the chemical reactions are reversible. When the cell is being charged, the anode becomes the positive (+) and the cathode the negative (−) electrode. This is also the case in an electrolytic cell. When the cell is being discharged, it behaves like a primary cell, with the anode as the negative and the cathode as the positive electrode.

According to example embodiments, on a continuous basis, the positive and negative DC voltage applied to each portion of the electrodes is reversed after a predetermined time constant. For example, a DC voltage that is set in a first phase of operation may apply a DC voltage to the electrodes for a time period of 30-90 seconds. Once the predetermined amount of time has expired, the DC voltage may be reversed so that the electrode assembly reverses the positive to negative flow of current. In other words, each of the positive voltage electrode cells or chambers may be reversed to a negative voltage for an equal amount of time. The reverse in DC voltage polarity will reduce the amount of sediment deposits from over growth and will cause cluster forming to occur. The clusters may be formed and the polymer solution added to the water is then able to react to the clusters and form heavy solids which promptly fall from suspension in the cathode water cells and are easily removed by a filtering or other sediment removal process. Once the solids have reacted with the polymers the sediment will collect on the bottom of the electrodes and may be removed via any known filtering operation.

The electrodes are coupled to a DC power supply that delivers, voltage while the waste water is forced through the electrodes at a predetermined rate (GPM). The electrical charge is applied to the electrodes identically in a uniform manner. Alternatively, the voltage is applied in an alternating variation of one electrode at a time receiving a particular voltage and polarity and the next electrode receiving a different voltage and polarity than the previous electrode in the electrode array.

The ten electrode assembly of FIG. 2 includes identical electrodes. More electrodes may be added if necessary in a series configuration so the same water may flow from each electrode until all of the electrodes have processed the same set of water that has flowed from one electrode to another in a series configuration. The electrodes may be bi-metallic each electrode having two different metals in concert with the water, such as aluminum and steel, one then the other which are not the same. Each electrode is exposed to all the water, and all electrodes carry the same charge.

One example configuration includes a voltage source 210 applying a constant DC voltage to each of the plurality of electrodes 220 for a predetermined amount of time (e.g., 30-90 seconds). After the time has expired, the voltage is reversed from a positive voltage to a negative voltage for another predetermined amount of time (e.g., 30-90 seconds).

In operation, an oscillating DC current is set for a first polarity for a predetermined time interval. Upon expiration of the predetermined time interval, the DC voltage changes polarity and oscillates back to a different DC current direction than the first current direction. According to one example, the time interval is 60-90 seconds that the voltage stays positive then moves back to negative for a 100 gallon a minute system. Multiple intervals of DC voltage oscillation may occur in a single cycle of water treatment for a single portion of water.

With the oscillation current changing, sediment clusters are forming in the water based on the coalescing and coagulation cycle. A final chemical being added consolidates the cluster metals and non-metals to create positive ions and negative ions (anions and cations) based on the cathode and anode in each electrode. For example, an anode after 60 seconds may become an anode. The anode would have a buildup of sediment if oscillation of the DC voltage did not occur. The cathode and anode are constantly changing reversing polarity every interval.

The change in polarity causes cluster formation, and free-falling of the metals, the anions are nonmetals and the cations are metals, once the clusters are formed, the chemical polymer brings the clusters into a settling form that drops quickly to the bottom of the electrode chamber for removal. The metals and non-metals are kept from attaching to the electrodes. The attachment of the metals and non-metals is avoided by the periodic reversing of the DC voltage.

According to example embodiments of the water treatment device of FIG. 1, the initial step in the process is the transfer of the flow back “frac-water” volume from the “fracturing” process, which generally occurs at oil and gas wells being explored and drilled anywhere in the world. The configuration of FIG. 1 includes an “overflow” frac tank (see 300 of FIG. 3) that acts as an intercept of the water from the well site to be treated and which is a part of the treatment process because it enables solids to settle and offers a large enough basin for the wastewater process to proceed in an orderly manner of “pre-treatment” and it is after this “overflow frac tank” receives the fracturing and ground water from the well site that the treatment device of FIG. 1 begins its task of remediation.

Referring to FIG. 3, the dirty water may flow from a direct line 312 into a multiple part tank including a first tank portion 312, a second tank portion 316 and a third tank portion 318. The multiple tank configuration may be used to separate the water into designated chambers for pre-treatment prior to the water being pumped back out via the pump interface 320. According to example embodiment, the dirty water treatment may be a dual-technique that consists of a primary injection and pre-treatment utilizing a gaseous input referred to as “Ozone” that is a hybrid three-atom series of molecules that form a compound known as O₃, which has three atoms of oxygen.

The second phase of this dual-technique procedure is referred to as “electro-coalescing” that includes of a “direct current” power supply, electrical charges and a steady flow of “frac water” being combined in a series of bi-metallic electrode cells as illustrated in FIG. 2, which are exposed to a set of pH modification and polymer injection procedures. The “ozone” and “electro-coalescing” operations provide electro-chemical aggregation of heavy metals, organic and inorganic colloids, etc., to produce a coagulated mass capable of being easily separated (by gravity) or removed from the water by settling or filtration once the treatment procedure approaches completion.

The dual-operation procedure of the two sub-operations used to perform a frac water treatment cycle may provide isolating the ozone as an initial independent “pre-treatment” injection into the “frac tank” after receiving the frac water from a well site. The duration of this ‘pre-treatment” cycle is dependent on a volume of water entering the frac tank inventory. One standard rule may be for every 30,000 gallons of water entering the “frac tank” one hour of injection time is desired, and as a result a “closed loop” circulation of ozone enriched “frac water” may be employed.

Experimentation and test procedures demonstrated that “frac water” has a tendency to be generated in the “acid mode” (e.g., 5.0-6.5 pH) and as this occurs it has been established that the most successful treatment cycles can only be accomplished if the “frac water” has a modified pH level above 9.1-9.4 pH. Therefore, to assist with this pH modification operation a continuous injection of sodium hydroxide (NaOH) is metered into the frac water as it passes through the frac tank and eventually through the ozone generation cycle followed by entry into the electrode assemblies 200 en-route to a final electro-coalescing operation.

At this point, the “frac water” is pre-conditioned and ready to be moved forward into the next extraction cycle known as “coalescing”, which is where the frac water enters the treatment device and is diverted through a series of 10 electrode assemblies. The electrode assemblies are chambers where the water can make contact with 100 sacrificial metal electrodes and energized by a source of DC (direct current) power with an optional range of 200-400 amps DC.

Ozone by definition is a three (oxygen) atom molecule known as O₃ and it differs from the air breathed which contains a two (oxygen) atom molecule known as O₂. The smallest whole piece of any molecular element is an atom, which are electrically charged and are seldom stable by themselves. Single oxygen atoms are electrically attached together to form molecules and that is the same process used to form ozone. That oxygen atomic status becomes increasingly unstable and as this reaction goes to completion, air and oxygen are drawn through a high energy chamber that bombards the molecules causing them to split back into “singlet oxygen atoms”. A greater level of instability then takes place and the ozone (three atom) molecule is now in constant contact with other molecules in the “frac water”. As a result, there is a tendency for singlet oxygen atoms to be roaming which tends to pull electrical energy from these molecules and their molecular structure is now altered even to the point where solids are precipitated and coagulated. This process of “ozone attack” and “co-mingling” with other molecular structures is called “oxidation” and is part of the treatment component going forward to the next level of “frac water remediation”.

In order to produce suitable ozone for the frac water remediation process a source of oxygen must be available and air can be used except that since there is only 21% oxygen in air a more effective technique is to employ an oxygen concentrator that extracts the oxygen from the air and guarantees a minimum of 90% oxygen by using a high energy reaction chamber that splits the oxygen atoms away from nitrogen and facilitates the production of a high purity ozone (e.g., over 90% pure).

Electro-coalescing by definition is the term used to describe the process of flowing contaminated/dirty frac water directly between sacrificial metal electrodes connected to a source of direct current (DC) at 200-400 amps DC power. The power supply employs a discipline of reversing voltage polarity which is integrated with the electrode assemblies. This technique functions as a mechanism of creating metal hydroxides and non-metal hydroxides that are coagulated into clusters that make the waste water or frac water become a conductive medium in the presence of the DC electric field in and around the electrodes, thus enhancing the ease of coagulation, clustering, collection, settling or filtration as the frac water progresses through the system into a finished cleaner water.

Reversing voltage polarity refers to the fact that each electrode possesses a positive and negative electrical charge, however, every 90 seconds the power supply activates a reversing mechanism that reverses the charges so that each electrode cannot retain a charge long enough to impact sediment collections on each electrode. That concept further proves the efficient performance of the remediation procedure.

FIG. 2 illustrates an example of the electrode and voltage application portion of the water treatment device according to example embodiments. The electrode assembly 200 includes a DC power supply 210 connected to an electrode array of electrodes setup in series as pairs 220 of electrode chambers 222 where the electrical charge is configured to contact the frac water. The wire pair 212 provides a negative and positive polarity from the DC power supply to each electrode chamber 222. The chambers are paired by two connecting wires 213 which permit the positive and negative polarities of the voltage source to be striped across the two electrode chambers. A cross-over conduit 215 provides a series electrical connection to be striped across all electrodes of the electrode array 200.

The example methods of operation performed by the electrodes may destroy bacteria. For example, the electrical field along with the electro-chemical and oxidation reactions at the surface of the electrodes kills bacteria up to 99.9%. The process may oxidize metals and the process of electrolysis produces an oxidative effect which oxidizes the contaminants as they flow between the bi-metallic electrodes. This will enable the solids collected to meet the EPA toxicity characteristic leaching procedure (TCLP) standards. Also, cellular dewatering may occur so the electric field and high oxidation rate causes organisms and water bound cellular structures to rupture which further reduces sludge volumes.

Another feature of the present device and its operations provides coagulation by the electrical field within the electrode cells, which neutralizes the charge of contaminants and thus increasing their removal. As a result of the ozone and electro-coalescing operations, the treated water will have signs of clarity but may still carry a level of turbidity (microscopic suspended solids) due to the complex chemistry employed in the fracking and flow-back water. Those water sources may carry a high level of stable sulfates, surfactants and emulsifying agents along with petroleum hydro-carbons (TPH) and (VOC) (volatile organic compounds), which makes it difficult to eradicate and remove those substances 100% without some additional process assistance.

According to example embodiments, at this juncture the combination of “electro-coalescing” and “ozonation” have thoroughly made contact with 100% of the pH modified “fracturing water” and the result of these combined disciplines and methodology has now yielded only a “semi-treatment” of the water, and this partial treatment cycle, a microscopic colloidal suspension of the major contaminants may still be present due to the complex water chemistry being derived from the “fracturing” procedures that are not fully engaged by the “ozone and electro-coalescing” treatments.

The composition of the “fracking” colloidal chemistry could have varying grades of toxic and non-toxic contaminants and the following known potential contaminants contained in the “fracking and other wastewater” have been successfully removed in accordance with the following table of elements and parameters identified from previous experimentation. The following removal results are typical for “electro-coalescing and ozonation” performance in wastewater remediation applications:

| Contaminant: | % Removal |
|---|---|
| Aluminum | 99.0% |
| Arsenic | 98.0% |
| Barium | 95.0% |
| Bacteria (HTC) | 99.0% |
| Copper | 99.0% |
| Chromium | 99.0% |
| Iron | 99.0% |
| Lead | 98.0% |
| Magnesium | 98.0% |
| Manganese | 75.0% |
| Nickel | 98.0% |
| Oil and grease (500 ppm | 99.0% |
| Phosphate | 80.0% |
| Strontium | 60.0% |
| Silver | 99.0% |
| Zinc | 95.0% |
| Chlorides | 35.0% |
| Boron | 80.0% |
| Sulfates | 80.0%. |

The remediation procedure also includes a microscopic bio-degradable additive composed of an emulsified soluble substance with known chemistry including an “Aluminum Chloride Hydroxy-Sulfate” known as compound #316-G polymer. This compound in its raw state is a hazardous substance, however, once it is integrated into the waste water in the presence of the “electro-coalescing and ozonation” activity it is rendered bio-degradable and non-toxic as a safely disposable mass capable of being sanitary land-filled.

This revitalization of the #316-G polymer is now dissolved in the “fracking” waste water and exhibits a final gathering and coagulation of the sub-micron suspended colloids that are now engulfed, enlarged and transformed into large clusters of solids from approximately 20-100 micron in size and capable of being settled or filtered for off-site removal to a sanitary land-fill in compliance with EPA TCLP standards.

After the solids are extracted and removed, a high quality solids-free clear liquid is ready to return to the oil exploration well sites where both drilling and fracking procedures can be serviced with the benefit of replacing the scarce water commodity with a recycled “flow-back” water in its place reducing the task and cost of disposal and resulting in a cost effective environmentally sound “hydraulic fracturing” result. However, the process is modified and optimized by using the remediation treatment process discussed in this disclosure. In order to reduce added contaminants, an oil separation module may be added to the remediation procedure as an adjunct module that intercepts all water entering into the cycle prior to the ozone/electro-coalescing procedure.

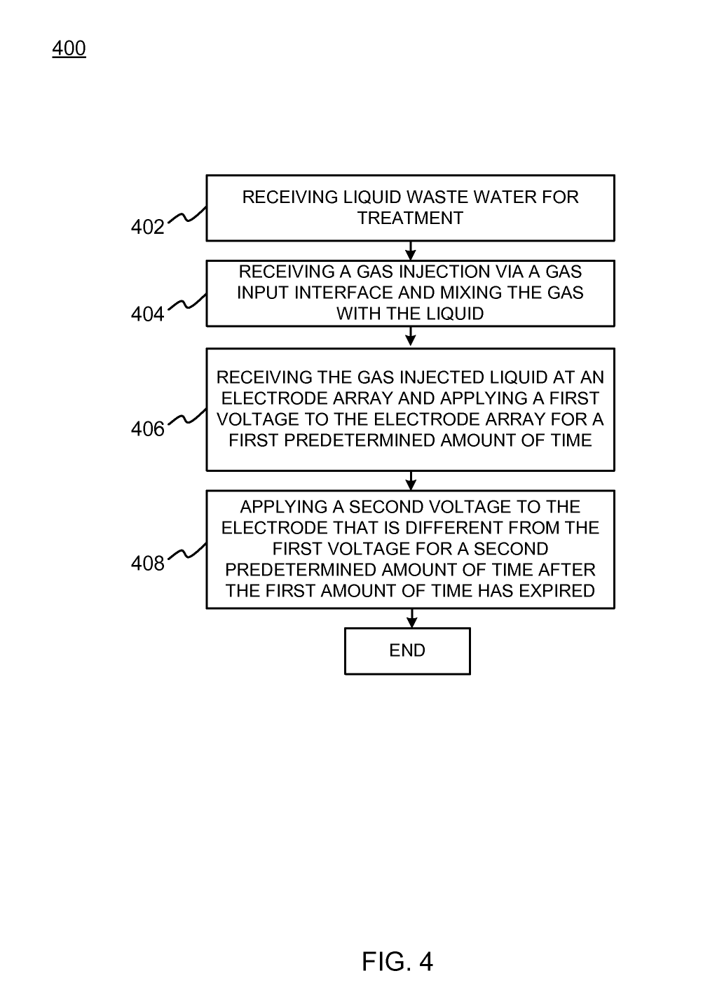

FIG. 4 illustrates an example flow diagram 400 of the operations included in an example method of operation. According to one example method of operation, the method may include receiving waste water liquid at operation 402. The method may also include injecting a gas into the liquid, at operation 404. The gas may be injected and then a predetermined amount of time may be waited until performing additional operations (e.g., 1 minute, 3 minutes or more). Next, the method may provide receiving the gas injected liquid and applying a first voltage to the electrode array for a first predetermined amount of time, at operation 406 and applying a second voltage to the electrode array that is different from the first voltage for a second predetermined amount of time after the first predetermined amount of time has expired, at operation 408 and removing sediment from the liquid. The flow of liquid through the electrode array is generally not performed until the liquid in the storage tank has had ample exposure to the ozone gas.

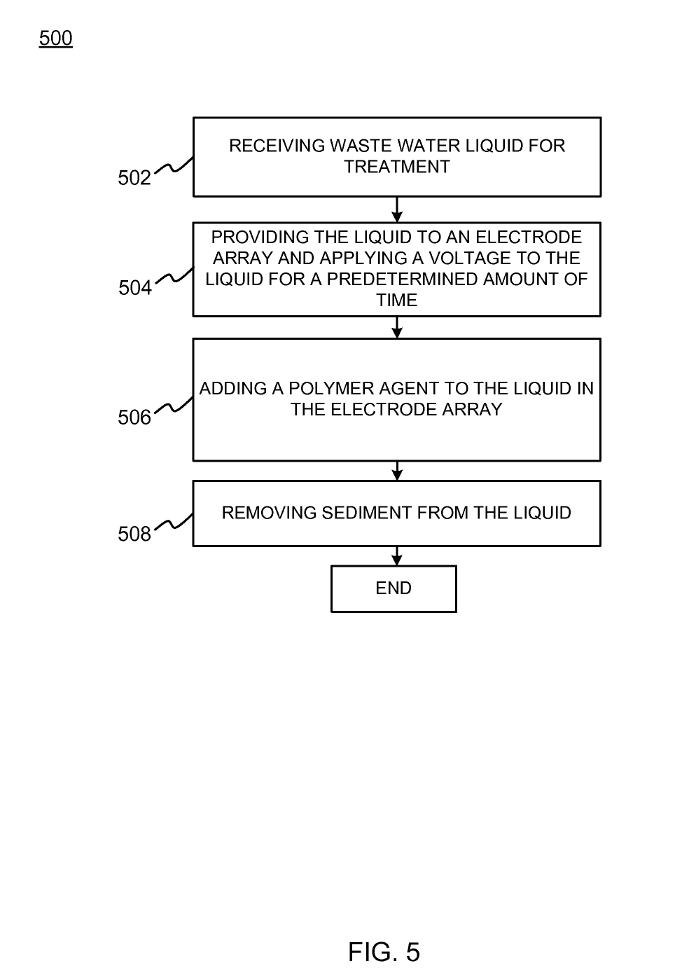

Another example method of operation is illustrated in the flow diagram 500 of FIG. 5. Referring to FIG. 5, the method may include receiving waste water for treatment at operation 502 and providing the liquid to an electrode array and applying a voltage to the electrode array for a predetermined amount of time at operation 504. The method may also include adding a polymer agent to the liquid in the electrode array at operation 506 and removing sediment from the liquid at operation 508.

What is claimed is:

1. An apparatus comprising:
a liquid input source that provides a flow of liquid;
a gas input source that provides a gas injection to the liquid; and
an electrode array comprising a plurality of electrodes configured to receive the liquid and apply a direct current voltage to the liquid.

2. The apparatus of claim 1, wherein the gas is a modified oxygen gas comprising three oxygen atom molecules.

3. The apparatus of claim 1, further comprising:
a power supply input interface that permits the electrical source to contact the liquid inside the electrode array.

4. The apparatus of claim 3, wherein the plurality of electrode cells each comprise at least one cathode and at least one anode, and wherein each of the electrode cells receives an electrical direct current (DC) voltage charge that is applied for a predetermined amount of time.

5. The apparatus of claim 4, wherein the predetermined amount of time is between 30 and 90 seconds.

6. The apparatus of claim 5, wherein after the predetermined amount of time has elapsed the polarity of the DC voltage is reversed and a reversed DC voltage charge is applied for another predetermined amount of time.

7. The apparatus of claim 6, wherein a pH reducing chemical is applied to the liquid and a polymer is applied to the liquid.

8. A method comprising:
receiving a flow of liquid via a forced liquid input interface;
receiving a gas injection via a gas input interface and mixing the gas with the liquid;
applying a voltage to the liquid for a predetermined amount of time; and
reversing the polarity of the voltage and applying the reversed polarity voltage to the liquid.

9. The method of claim 8, further comprising:
providing a pH reducing chemical to the liquid prior to applying the voltage to the liquid.

10. The method of claim 9, wherein the voltage and the reverse voltage are applied to a plurality of electrode cells each comprising at least one cathode and at least one anode, and wherein each of the electrode cells receive an electrical direct current (DC) voltage charge that is applied for a predetermined amount of time.

11. The method of claim 10, wherein the predetermined amount of time is between 30 and 90 seconds.

12. The method of claim 11, applying a polymer to the liquid after at least one of the voltage application and the reversed polarity voltage application has occurred.

13. An apparatus comprising:
an array of electrode cells configured to store a liquid;
a liquid interface source that provides a flow of liquid into the array of electrode cells, the liquid comprising a plurality of sediment materials;
a power supply interface in contact with the liquid and configured to receive a voltage source; and
a chemical interface configured to receive a polymer that mixes with the liquid in the electrode cells during application of the voltage source.

14. The apparatus of claim 13, wherein the power supply interface receives the electrical charge from a direct current (DC) power supply.

15. The apparatus of claim 14, wherein the DC power supply applies a DC voltage to the liquid for a predetermined period of time.

16. The apparatus of claim 15, wherein the DC voltage is applied at a first polarity to the liquid for the predetermined period of time.

17. The apparatus of claim 16, wherein the DC voltage is applied at a second polarity different from the first polarity to the liquid for another predetermined period of time.

18. The apparatus of claim 14, wherein the array of electrode cells comprise at least two electrode cells connected in a series wiring configuration.

19. The apparatus of claim 14, wherein the array of electrode cells comprise a plurality of electrodes each comprising an anode and cathode.
